(19) United States
(12) Patent Application Publication
(10) Pub. No.: US 2003/0134127 A1
(43) Pub. Date: Jul. 17, 2003

(54) Alcohol-blocked polyisocyanates for coil coating

(76) Inventors: Eberhard Konig, Leverkusen (DE); Karl-Ludwig Noble, Leverkusen (DE); Christian Fussel, Tonisvorst (DE); Eberhard Jurgens, Koln (DE)

Correspondence Address: BAYER POLYMERS LLC, 100 BAYER ROAD, PITTSBURGH, PA, 15205, US

(21) Appl. No.: 10/204,891

(22) PCT Filed: Feb. 2, 2001
(86) PCT No.: PCT/EP01/01118

(30) Foreign Application Priority Data
Feb. 15, 2000 (DE) 100 06 649.6

(51) Int. Cl. B32B 17/06; C08G 18/16

(52) U.S. Cl. 428/433; 524/385

(57) ABSTRACT

The invention relates to novel blocked aliphatic polyisocyanate cross-linking agents and use thereof in one-component stoving lacquers, in particular for the coil coating process.

This invention relates to novel blocked aliphatic polyisocyanate cross-linking agents and use thereof in one-component stoving lacquers, in particular for the coil coating process.

It is known prior art to formulate blocked polyisocyanates with OH-containing polycondensates or polymers (polyesters or polyacrylates) to produce binders for “one-component” stoving lacquers. Butanone oxime is a proven isocyanate blocking agent, because its properties offer a good price/performance ratio. Butanone oxime has recently come under criticism from a physiological point of view. It is therefore essential to replace butanone oxime with physiologically less questionable or wholly unquestionable blocking agents.

It is known that alcohols react with isocyanates to produce the thermally very stable urethane group. This means, on the other hand, that isocyanates blocked with alcohol require very high stoving temperatures in order to regenerate the isocyanate. Very high stoving temperatures are used in wire coating and electrocoating (cathodic electrocoating). Aromatic polyisocyanates blocked with alcohols are used in these applications. The following relatively recent patent applications relating to cathodic electrocoating lacquers with alcohol blocking of the isocyanate cross-linking agents are cited by way of example: EP-A 0 677 539 and WO 96/12771. Another patent application (EP-A 0 319 709) describes alcohol-blocked cross-linking agents for electrocoating lacquers with low stoving temperatures, at any rate “below 160° C. and ≦30 mins”. This reduction in stoving temperatures is achieved by using special alcohols, e.g. furfuryl alcohol. On the other hand, it must be taken into account that the stoving temperature must be raised again by approximately 10° C. in the case of blocked, lightfast aliphatic polyisocyanates, since these release the NCO group less readily than aromatic polyisocyanates.

No alcohol-blocked polyisocyanate cross-linking agents have hitherto been known for the coil coating process, which requires high temperatures but very short residence times, e.g. an object temperature of 232° C. and a residence time of 35 secs. In such instances, butanone oxime was the blocking and cleaving agent of choice, because, as the last Example explains, it is relatively easy to eliminate from the isocyanate compound.

It was therefore the object of the invention to develop conditions under which alcohol-blocked aliphatic polyisocyanates may be used as coil coating lacquers.

This object was achieved with the products according to the invention.

The invention provides coil coating lacquer binders comprising aliphatic polyisocyanates blocked with aliphatic alcohols and organic polyhydroxyl compounds, characterised in that

a) the aliphatic alcohol has a boiling point of up to 120° C. and

b) the lacquer binder contains 1.2 to 4.0 wt. %, preferably 1.5 to 2.5 wt. %, relative to the solids content of the binder components, of catalysts from the group consisting of tetravalent organotin compounds.

Essential features of the invention, with regard to the coil coating binder according to the invention, are blocking of the aliphatic polyisocyanate with aliphatic alcohol and the type and amount of catalyst, namely 1.5 to 2.5 wt. %, preferably 2.0 wt. % of organotin(IV) compounds, relative to the solids content of cross-linking agent and polyhydroxyl compound.

A coil coating lacquer according to the invention is composed (e.g. Example 4) of binder components, a catalyst, a pigment, various flow control agents and solvents.

The binder components of a coil coating lacquer according to the invention consist of a blocked polyisocyanate cross-linking agent according to the invention and at least one commercially available resin carrying polyfunctional hydroxyl groups, e.g. a polyester and/or a polyacrylate as polyhydroxyl compound.

Suitable cross-linking agents according to the invention are the lacquer polyisocyanates known per se, comprising biuret, isocyanurate, allophanate, iminooxadiazinedione (asymmetric trimer), urethane and/or uretdione groups and based on (cyclo)aliphatic diisocyanates with an NCO content of from 12 to 25 wt. %. Examples of aliphatic or cycloaliphatic diisocyanates are 1,6-diisocyanatohexane (HDI), 1-isocyanato-3,3,5-trimethyl-5-isocyanatomethylcyclohexane (isophorone diisocyanate, IPDI), bis-(4-isocyanatocyclohexyl)methane (H₁₂ MDI or Desmodur W®/Bayer AG), 2,6- or 2,5-bisisocyanatonorbornane or 1,4-bisisocyanatomethylcyclohexane. Polyisocyanates predominantly containing isocyanurate groups and based on 1,6-diisocyanatohexane, IPDI and Desmodur W® are preferred.

Suitable blocking agents for polyisocyanates for use according to the invention include low-boiling aliphatic alcohols, e.g. straight-chain or branched or cycloaliphatic C₁-C₅ aliphatic alcohols, preferably methanol, ethanol, propanol, isopropanol, butanol (boiling point 117° C.), isobutanol (boiling point 107° C.) or 2-pentanol (boiling point 116° C.). Ethanol is particular preferred. Mixtures of alcohols may also be used.

Suitable catalysts according to the invention are tetravalent organotin compounds. Examples thereof are preferably dibutyltin dilaurate (DBTL), dibutyltin diacetate, dibutyltin maleate or tetrabutylstannoxane diacetate. So-called ®Swedstab OTO-133 (made by AWL Scandinavia AB), consisting of:

| | |
|---|---|
| 35-45 wt. % | monooctyltin triisooctylthioglycolate |
| 30-40 wt. % | dioctyltin diisooctylthioglycolate |
| 1-5 wt. % | monobutyltin triisooctylthioglycolate |
| 1 wt. % | bisphenol A |
| 100 wt. % | OTO-133 |

is particularly preferred.

These tin catalysts are mixed with a coil coating lacquer having the cross-linking agent according to the invention in an amount of from 1.2 to 4.0 wt. %, preferably 1.5 to 2.5 wt. %, particularly preferably 2.0 wt. %, relative to the solids content of the binder, i.e. cross-linking agent and OH-containing resin.

The binder components of the coil coating lacquer are added in an equivalent amount to the functional groups, such that the following ratio applies: blocked NCO groups:OH groups=1:1.

The novel polyisocyanate cross-linking agents with alcohol blocking constitute a good alternative to butanone oxime-blocked cross-linking agents for coil coating lacquers. Although the reactivity of the novel cross-linking agents is not quite as good as that of those blocked with butanone oxime, this is compensated by advantages with regard to resistance to yellowing. The whiteness values are improved both in the case of stoving and overstoving or annealing.

They are preferably used for lacquer coating of sheet metal.

### EXAMPLES

### Example 1

(according to the invention)

Production of a polyisocyanate cross-linking agent blocked with ethanol.

a) Starting materials

| 196.0 g | (1.0 equiv) | of an isocyanurate-containing lacquer | |
|---|---|---|---|
| | | polyisocyanate based on 1,6-diisocyanatohexane | |
| | | (HDI) with an NCO content of 21.4 wt. %, a | |
| | | viscosity at 23° C. of approx. 3000 mPas and a | |
| | | functionality of approx. 3.5 | |
| 50.6 g | (1.1 mol) | ethanol (boiling point 78° C.) | |
| 82.2 g | | solvent naphta 100 | |
| 328.8 g | (1.0 equiv) | blocked NCO groups | |
| | | solids content: | 242 g, 73.6 wt. % |
| | | appearance: | colourless, clear |
| | | viscosity (23° C.): | approx. 1450 mPas |
| | | blocked NCO content: | calc. 12.7 wt. % |
| | | 1 equiv blocked NCO | 328.8 g |
| | | groups: | |

b) Performance

Polyisocyanate and solvent are initially introduced with stirring at approximately 40° C. Ethanol is added dropwise in such a way that, despite the exothermic reaction, the internal temperature does not exceed 85° C. After approx. 1 hour of dropwise addition and ½ hour of subsequent stirring at 85° C., there is no longer any detectable NCO content (IR spectrum). The mixture is allowed to cool, is discharged and the blocked cross-linking agent solution characterised above is obtained, with a blocked NCO equivalent of 328.8 g.

### Example 2

(according to the invention)

Production of a polyisocyanate cross-linking agent blocked with isopropanol.

a) Starting materials

| 196.0 g | (1.0 equiv) | of an isocyanurate-containing lacquer | |
|---|---|---|---|
| | | polyisocyanate based on 1,6-diisocyanatohexane | |
| | | (HDI), c.f. Example 1, trimerised | |
| | | HDI with an NCO content of 21.4 wt. % | |
| 66.0 g | (1.1 mol) | isopropanol (boiling point 82° C.) | |
| 79.4 g | | 1-methoxypropyl acetate | |
| 341.4 g | (1.0 equiv) | blocked NCO groups | |
| | | solids content: | 256 g, 75.0 wt. % |
| | | appearance: | colourless, clear |
| | | viscosity (23° C.): | approx. 1400 mPas |
| | | blocked NCO content: | calc. 12.3 wt. % |
| | | 1 equiv blocked NCO | 341.4 g |
| | | groups: | |

b) Performance

As per the method described in Example 1b).

### Example 3

(according to the invention)

Production of a polyisocyanate cross-linking agent blocked with isobutanol.

a) Starting materials

| 196.0 g | (1.0 equiv) | of a trimerised HDI according to Example 1a) | |
|---|---|---|---|
| | | with an NCO content of 21.4 wt. % | |
| 81.4 g | (1.1 mol) | isobutanol (boiling point 107° C.) | |
| 82.6 g | | 1-methoxypropyl acetate | |
| 360.0 g | (1.0 equiv) | blocked NCO groups | |
| | | solids content: | 270 g, 75.0 wt. % |
| | | appearance: | colourless, clear |
| | | viscosity (23° C.): | approx. 1100 mPas |
| | | blocked NCO content: | calc. 11.7 wt. % |
| | | 1 equiv blocked NCO | 360.0 g |
| | | groups: | |

b) Performance

The components listed under starting materials are processed, as described in Example 1b), to produce the cross-linking agent blocked with isobutanol and having a blocked NCO equivalent of 360 g.

### Example 4

(according to the invention)

The production of a white coil coating lacquer with the cross-linking agent according to Example 1 is described, together with the processing conditions and properties thereof.

a) Lacquer production

| | Amount | Solids content | | |
|---|---|---|---|---|
| Binder components | [g] | [g] | Equivalent | Wt. % |
| i) blocked NCO cross- | 147.6 | 108.6 | 0.449 equiv NCO | |
| linking agent according to | | | | |
| Example 1 | | | | |
| ii) hydroxyl polyester | 449.0 | 291.8 | 0.449 equiv OH | |
| Alkynol ® 1665¹⁾ | | | | |
| Swedstab OTO-133²⁾ | 80.0 | 8.0 | | 2 |
| 10 wt. % in solvent | | | | rel. to solids |
| naphta³⁾ 200 S | | | | content i) + ii) |
| Total binder components | 676.6 | | | |

¹⁾Alkynol ® 1665, hydroxyl polyester, 65% in solvent naphta 100/isobutanol, 1.7 wt. % OH groups, OH equivalent = 1000 g, Bayer AG
²⁾Swedstab OTO 133, mixture of:
approx. 45% monooctyltin triisooctylthioglycolate
approx. 40% dioctyltin diisooctylthioglycolate
approx. 4% monobutyltin triisooctylthioglycolate
1% bisphenol A
AWL Scandinavia AB, Malmö, Sweden
³⁾Solvent naphta, Deutsche Exxon Chemical GmbH, Cologne

The above binder is contained in the following white lacquer. The blocked NCO cross-linking agent (Example 1) and the hydroxyl polyester are present in an NCO:OH ratio of 1:1. To enable curing of the binder, the above mixture contains 2 wt. % (relative to the functional binder components/solids content) of tetravalent tin catalysts.

| | |
|---|---|
| Total of binder components (see above) | 676.6 g |
| Additional lacquer components are: | |
| TiO₂ Kronos 2330⁴⁾ | 402.4 g |
| solvent naphta 200³⁾ | 107.5 g |
| Acronal 4F⁵⁾, 50% in SN 200 S³⁾ | 20.1 g |
| CAB 531-1⁶⁾, 10% in SN 200 S³⁾ | 100.0 g |
| solvent naphta 200 S³⁾ | 33.4 g |
| Total lacquer components | 1340.0 g |

⁴⁾White pigment, Kronos International, Leverkusen
⁵⁾Flow control agent + defoaming agent, polybutyl acrylate, BASF, Ludwigshafen
⁶⁾CAB 531-1, cellulose acetobutyrate, Krahn Chemie Hamburg, Producer: Eastman Kingsport, USA

The above white lacquer is prepared, by mixing a ground paste made of the polyester, titanium dioxide pigment and solvent naphta 200 homogeneously with the other components. This lacquer has a DIN 4 cup draining time of 120 secs.

b) Lacquer curing and testing

The above lacquer is applied with coating knives to chromated (1 mm thick) aluminium sheets. The dry film thickness amounts to from 19 to 22 μm. Immediately after lacquer application, the sheets are stoved in an Aalborg furnace on a rotary table at a furnace temperature of 350° C. and for variable residence times.

A residence time of 41 secs results in a peak metal temperature (PMT, object temperature) of 241° C. The lacquer cured in this way has the following properties:

TABLE
Lacquer properties

| | |
|---|---|
| Gardener gloss 20/60° as ECCA-T2¹⁾ | 77/90 |
| Microhardness (10 g - 30 secs) | 6.6/6.0 |
| Impact test (inch/lbs) as ECCA-T5 | 80 |
| Adhesion 6 mm Erichsen indentation with cross- | 0 |
| hatching ECCA-T6 | |
| T bend test T 0.0 | tears 0 |
| 0 = best value | adhesion 0 |
| Berger whiteness | 96.3 |
| Berger whiteness with PMT > 254° C. | 94.2 |
| Subsequent tensile test 10′ 100° C. | T 1.0 (good) |
| Methyl ethyl ketone (MEK) swab test, to-and-fro | 100 |
| strokes, ECCA¹⁾ T11 and DIN EN 12720 | |

¹⁾ECCA = European Coil Coating Association

As is revealed by the above Table, the white coil coating lacquer requirements are easily met.

### Example 5

(according to the invention)

White coil coating lacquers having the various cross-linking agents of Examples 1 to 3 are compared. The type of catalyst and the object temperature also vary.

Lacquer 1a) corresponds to Example 4. Lacquer 1b) corresponds to lacquer 1a) except for the type of catalyst. Dibutyltin dilaurate (DBTL) is used instead of Swedstab OTO-133. Lacquers 2 and 3 each contain the cross-linking agents according to Examples 2 and 3 blocked with isopropanol or isobutanol respectively. Adequate cross-linking of these lacquers under different stoving conditions is determined using the MEK swab test (ECCA T11 and DIN EN 12720). If the lacquer withstands 100 MEK to-and-fro strokes without damage, the lacquer is sufficiently cross-linked or completely reacted.

| Lacquer | 1a | 1b | 2a | 2b | 3a | 3b |
|---|---|---|---|---|---|---|
| Blocking | Ethanol | | Isopropanol | | Isobutanol | |
| agent | | | | | | |
| Swedstab | 2 wt. % | — | 2 wt. % | — | 2 wt. % | — |
| OTO-133 | | | | | | |
| DBTL | — | 2 wt. % | — | 2 wt. % | — | 2 wt. % |
| Reactivity | | | | | | |
| (MEK swab | | | | | | |
| test) at | | | | | | |
| PMT 241° | 100 | 100 | 100 | 100 | 100 | 100 |
| C./41 secs | | | | | | |
| PMT 232° | 100 | 15 | 70 | 5 | 80 | 5 |
| C./38 secs | | | | | | |
| PMT 224° | 100 | — | 10 | — | 10 | — |
| C./35 secs | | | | | | |

As may be seen, ethanol is the “most reactive” blocking agent of the alcohols tested and Swedstab OTO-133 is the more effective catalyst, since lacquer 1a) is the only one of the above group to pass the MEK swab test with an object temperature of 224° C. and a residence time of 35 secs.

### Example 6

(according to the invention)

The reactivity of the lacquer according to Example 4 is described as a function of various catalyst quantities under relatively low stoving conditions.

| Lacquer | 1c | 1a | 1d |
|---|---|---|---|
| Blocking agent | Ethanol | Ethanol | Ethanol |
| Swedstab OTO-133 | 1.0 wt. % | 2.0 wt. % | 3.0 wt. % |
| relative to solids | | | |
| content/binder | | | |
| Reactivity (MEK swab test) at | | | |
| PMT 216° C./33 secs | — | 50 | 60 |
| PMT 224° C./35 secs | 10 | 100 | 100 |

As may be seen, cross-linking cannot be imposed at an object temperature of 216° C./33 secs even by increasing the catalyst to 3 wt. % relative to solids content/binder.

### Example 7

(Comparative Example)

The comparison is described of white lacquers with ethanol-blocked cross-linking agents and a similar butanone oxime-blocked cross-linking agent.

In the case of the following lacquer 4, the cross-linking agent having ethanol as blocking agent is replaced in the white lacquer according to Example 4 by one with butanone oxime as blocking agent. The catalyst quantity is also reduced.

| | 1a (acc. | |
|---|---|---|
| Lacquer | to Ex. 4) | 4 |
| Blocking agent | Ethanol | Butanone oxime |
| Swedstab OTO-133 | 2 wt. % | 1 wt. % |
| relative to solids content/binder | | |
| Reactivity (MEK swab test) at | | |
| PMT 224° C./35 secs | 100 | 100 |
| PMT 216° C./33 secs | 50 | 100 |
| Berger whiteness under | | |
| overstoving conditions | | |
| PMT 232° C./38 secs | 94 | 94 |
| (initial value) | | |
| +120 hrs at 120° C. | 82.0 | 80.9 |
| +24 hrs at 150° C. | 80.5 | 72.9 |

As may be seen, the white lacquer 4 blocked with butanone oxime is more reactive than the white lacquer 1a) blocked with ethanol, since, at an object temperature of 216° C./33 secs., lacquer 4 passes the MEK swab test, while lacquer 1a no longer does. However, the butanone oxime-containing lacquer 4 yellows more under overstoving conditions than lacquer 1a), which finds expression in the more marked reduction in whiteness values.

The two white lacquers 1a) and 4 were also tested under stoving conditions conventional in automobile lacquer coating, namely at 140° C./30 mins.

| Lacquer | 1a (acc. Ex. 4) | 4 |
|---|---|---|
| Blocking agent | Ethanol | Butanone oxime |
| Swedstab OTO-133 | 2 wt. % | 1 wt. % |
| relative to solids content/binder | | |
| Reactivity (MEK swab test) at | — | 100 |
| 140° C./30 mins. | | |

Under these wholly different stoving conditions, where no stoving temperature ≧224° C. has to be withstood, the lacquer 1a) with alcohol blocking fails completely.

1. Coil coating lacquer binders comprising aliphatic polyisocyanates blocked with aliphatic alcohols and organic polyhydroxyl compounds, characterised in that
a) the aliphatic alcohol has a boiling point of up to 120° C. and
b) the lacquer binder contains 1.2 to 4.0 wt. %, relative to the solids content of the binder components, of catalysts from the group consisting of tetravalent organotin compounds.

2. Coil coating lacquer binders according to claim 1, characterised in that they contain 1.5 to 2.5 wt. % organotin(IV) compounds as catalyst.

3. Coil coating lacquer binders according to claim 1, characterised in that the polyfunctional hydroxyl group-carrying resin is a polyester.

4. Coil coating lacquer binders according to claim 1, characterised in that the polyfunctional hydroxyl group-carrying resin is a polyacrylate.

5. Coil coating lacquer binders according to claim 1, characterised in that the polyfunctional hydroxyl group-carrying resin is a mixture of polyester and polyacrylate.

6. Coil coating lacquer binders according to claim 1, characterised in that ethanol is used as blocking agent for the polyisocyanates.

7. Use of coil coating lacquer binders according to claim 1 for lacquer coating of sheet metal.
